(19) United States
(12) Patent Application Publication
(10) Pub. No.: US 2026/0339762 A1
(43) Pub. Date: Oct. 29, 2026

(54) REMOTE PROCEDURE CALLS FOR PRIVATE BRANCH EXCHANGE OPERATIONS WITHIN PROTECTED NETWORKS

(71) Applicant: G.S. CONSULTING & RESEARCH CORRENET LTD, Nes Ziona (IL)

(72) Inventor: Oran Moshe, Mashen (IL)

(21) Appl. No.: 19/192,486

(22) Filed: Apr. 29, 2025

(51) Int. Cl. G06F 9/54

(52) U.S. Cl. CPC G06F 9/547

(57) ABSTRACT

A method, apparatus and computer program product, the method comprising: dequeuing a message by a connector in an environment where a client and a queue are external to a protected network while a device executing the connector and a server are within the protected network, the message generated in response to executing a stub PBX method by the client, the stub associated with a server PBX method, the message inserted into the queue by the client indicates a command to execute the PBX method; and in response to dequeuing, executing a connector PBX method associated with the PBX method, wherein the server has an API for invoking methods, wherein the PBX method is comprised in a subset of the methods, the subset comprising methods enabled to be remotely operated via the queue, comprising the PBX method and excluding an API method, thereby performing an RPC instructed by the client.

### TECHNICAL FIELD

The disclosure generally relates to the field of communication, and specifically to performing procedure in a protected network by a client device external to the protected network.

### BACKGROUND

A communication system, including a telephony system is one of the most significant backbones of many organizations, such as commercial companies, educational institutes, banks, government offices, NGOs, or others.

A significant part of organizations use communication networks comprising one or more telephony systems, whether on-premise private exchange branches (PBXs), VoIP systems, modern cloud-based networks which offer significant advantages, or combinations thereof.

In many situations, communication networks of an organization or parts thereof are protected against viruses or other malicious intrusions by protective systems, such as a firewall. The protection systems are designed to monitor and filter incoming and sometime also outgoing network traffic, based on the organization's security policies.

However, such firewalls may sometime block transmission of required legitimate information. For example, information systems or other systems external to the protected network may need to consume data through network connectivity to the client's infrastructure which is protected by a firewall.

In another example, it may be required to activate functionality of a server, such as a PBX server, within the protected network from a client device external to the protected network. Such functionality may be required, for example, for adding, changing or deleting users, telephone lines, devices or other entities associated with the server, updating a version of the server, or the like.

The security measures can prevent or restrict the systems' ability to perform the required actions or access necessary data, leading to connectivity issues or limited access to resources.

### BRIEF SUMMARY

One exemplary embodiment of the disclosed subject matter is a method performed in a computerized environment, the method comprising: dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method, thereby performing a Remote Procedure Call (RPC) instructed by the client device in spite of the protection system of the protected network. Within the method, the computerized environment optionally comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components. Within the method, the protected network optionally comprises a plurality of sub-networks, wherein at least one sub-network from the plurality of sub-networks is associated with a separate message queue and comprising at least one PBX server. Within the method, the at least one sub-network optionally comprises a plurality of connectors, wherein each message enqueued to the message queue is collected by one of the plurality of connectors. Within the method, a plurality of message queues optionally associated with the plurality of sub-networks are managed as a queue cluster. Within the method, the protected network is optionally protected by a firewall. Within the method, the message queue and an interface accessed by the client device are optionally implemented in a cloud computer.

Another exemplary embodiment of the disclosed subject matter is a method performed in a computerized environment, the method comprising: installing a message queue within the computerized environment, wherein the computerized environment comprises the message queue, a client device, a PBX server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message queue is configured to receive messages from the client device; generating a stub PBX method to be executed by the client device, the stub PBX method configured to generate a message when executed by the client device, and insert the message into the message queue, the stub PBX method is associated with a PBX method of the PBX server, the message indicating a command to execute the PBX method by the PBX server, whereby enabling the client device to send an indirect message to the PBX server without being blocked by the protection system; generating a connector PBX method to be executed by the connector; and installing the connector component within the protected network, the connector component configured to: dequeuing the message from the message queue; and in response to obtaining the message, executing a connector PBX method associated with the PBX method, said executing the connector PBX method configured to cause execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method, thereby enabling a Remote Procedure Call (RPC) instructed by the client device in spite of the protection system of the protected network. The method can further comprise: providing a secret key to the connector; accessing by the connector using the secret key a source for obtaining configuration parameters; and enabling access of the connector to the message queue using the configuration parameters. Within the method, the protected network optionally comprises multiple PBX servers communicating with the connector component. Within the method, the protected network optionally comprises a plurality of connector components accessing the message queue, thereby providing redundancy in handling the message. Within the method, the protected network optionally comprises a plurality of separately protected sections, each of the plurality of protected sections comprises at least one PBX server and at least one connector component, and each of the plurality of protected sections associated with a separate message queue. Within the method, a plurality of message queues associated with the plurality of protected sections are optionally arranged in a cluster.

Yet another exemplary embodiment of the disclosed subject matter is a computerized apparatus having a processor, the processor being configured to perform: dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method, thereby performing a Remote Procedure Call (RPC) instructed by the client device in spite of the protection system of the protected network. Within the computerized apparatus, the computerized environment optionally comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components. Within the computerized apparatus, the protected network optionally comprises a plurality of sub-networks, wherein at least one sub-network from the plurality of sub-networks is associated with a separate message queue and comprising at least one PBX server. Within the computerized apparatus, the at least one sub-network optionally comprises a plurality of connectors, wherein each message enqueued to the message queue is collected by one of the plurality of connectors. Within the computerized apparatus, a plurality of message queues associated with the plurality of sub-networks are optionally managed as a queue cluster.

Yet another exemplary embodiment of the disclosed subject matter is a computer program product comprising a non-transitory computer readable storage medium retaining program instructions, which program instructions when read by a processor, cause the processor to perform instructions comprising: dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method, thereby performing a Remote Procedure Call (RPC) instructed by the client device in spite of the protection system of the protected network. Within the computer program product, the computerized environment optionally comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a network, in accordance with some exemplary embodiments of the disclosure;

FIG. 2 is a schematic illustration of a system architecture, in accordance with some exemplary embodiments of the disclosure;

FIG. 3 is a schematic illustration of yet another schematic illustration of a system architecture, in accordance with some exemplary embodiments of the disclosure;

FIG. 4 is a schematic illustration of yet another schematic illustration of a system architecture, in accordance with some exemplary embodiments of the disclosure;

FIG. 5 is a schematic illustration of the architecture and functions in a system, in accordance with some exemplary embodiments of the disclosure;

FIG. 6 is a block diagram of the entities in a system and their activities, in accordance with some exemplary embodiments of the disclosure;

FIG. 7 is a flowchart of steps in a method in accordance with some exemplary embodiments of the disclosure; and

FIG. 8 is a flowchart of steps in a method in accordance with some exemplary embodiments of the disclosure.

### DETAILED DESCRIPTION

In the disclosure below, the terms PBX, telephony system, telephone exchange system, and telephone communication system are used interchangeably.

A typical communication network in an organization comprises one or more telephone exchange systems, such as but not limited to private branch exchange (PBX) systems. A Private Branch Exchange (PBX) is a private telephone network used within a company or organization. The PBX allows users to communicate internally within the organization and externally with the public switched telephone network (PSTN). It typically includes features such as call transferring, voicemail, call recording, interactive voice menus, and call queues.

In addition, the network may comprise a management system, which is a centralized control and administration platform designed to oversee and manage one or more telephone exchange systems within the organization. This management system is adapted to communicate with, configure, and coordinate the various telephone exchange systems for implementing the business logic of the organization. Its functions may include, but are not limited to: setting or changing system configurations, starting or stopping PBX operations, backing up information, responding to requests issued by the telephone communication systems, managing user accounts, devices and telephone lines (e.g., adding, deleting or changing users, devices or lines), or the like. The management system may be useful in ensuring the smooth operation and efficient administration of the organization's communication infrastructure.

In some situations, the network or at least critical components of the communication network, for example one or more clusters comprising one or more servers, are protected by a protection system, such as a firewall.

A firewall may monitor and block at least the incoming and sometime also the outgoing communication to and from the protected network.

Thus, one technical problem associated with the disclosure relates to a need to instruct a server protected by a protection system to perform operations from a device external to the network of the server. The operations may include ongoing functionality and maintenance operations, that need to be carried out despite the protection system preventing or restricting the ability to access the servers or other resources.

For example, in PBX servers, such operations may include defining, adding, changing or deleting entities associated with the PBX server such as users, telephone line, or devices, or relations between entities such as Internet Protocol (IP) groups, hunt groups, or the like. The instructions may further relate to updating versions of the PBX server, shutting down or restarting a PBX server, or the like. A further operation that may not be carried out with a firewall may relate to the need of an external device to obtain information from a server, such as lists of users, telephone lines or servers, current settings, or the like.

Another technical problem associated with the disclosure relates to similar situations in any other network, wherein the servers may be other than PBX servers. Thus, an instruction to a server to perform an operation may not be delivered to the server due to the protection system blocking incoming communication.

Yet another technical problem associated with the disclosure relates to the need to control servers within the communication system, in a transparent manner from any device, whether within or external to the network, whether on-premise or remote, or the like.

One technical solution of the disclosure comprises performing a Remote Procedure Call (RPC) instructed by a client device external to the network, in spite of but without compromising the protection system of the protected network. The solution may comprise a message queue external to the protected network, the message queue also referred to as an “access point”. The solution may further comprise an application service, referred to as “proxy connection”, “connector component” or “connector”, installed within the protected network on one of the PBX servers or on any other device. Subject to performing an operation by a client device external to the protected network, the client device may enqueue a message to the message queue, wherein the message is indicative of the operation that needs to be carried out by a server within the protected network.

The connector which is within the protected network may receive information from the message queue which is external to the protected network.

Some messaging techniques, such as but not limited to RabbitMQ®, comprise a message queue and a message manager. When using such systems, when a consumer such as the proxy connector connects to the messaging systems, it establishes a persistent connection to the messaging manager over a socket. The message manager thus holds the connection open for the duration of the communication, and when a message is added to the queue, it immediately pushes it to the proxy connector, without the proxy connector having to ask or check the queue repeatedly. This is the push model. This way, the message manager can push messages to the consumer in real time as long as the socket remains open.

Thus, in such embodiments, the proxy connector connects to the messaging manager via a socket and subscribes to a queue. Once approved, the massaging manager holds the connection open, and pushes messages to the proxy connector when they become available. The proxy connector processes the message and sends an acknowledgment back to the messaging manager.

By the proxy connection receiving the message in real time or near real time, the proxy connection can initiate the required actions, for example adding, changing or deleting users, changing settings of communication servers, or the like.

In accordance with some exemplary embodiments of the disclosure, in order to activate certain functionality within the protected network, a client device may activate a method which enqueues a corresponding message to the message queue. The connector receives the message as described above and may, in response, activate a corresponding stub function which will cause a server indicated in the message to activate the corresponding functionality.

Thus, for each functionality of the server which is required to be operated, a stub function to be executed by the client device, and a skeleton function executed by the proxy connection may be provided. The stub and skeleton functions may be provided to a subset of the functions enabled, for example, by an API of the server, wherein the subset is partial to the full set of functions enabled by the API.

Another technical solution of the disclosure provides for installing a plurality of connectors, or proxy connections, for handling messages, thereby providing redundancy that can eliminate failures or lost messages. If no acknowledgement is received for handling a message received form the message queue within a predetermined period of time, the message may be re-enqueued to the queue, and dequeued and handled by another proxy connector. Thus, the failure of a proxy connector does not cause any message to go unhandled.

It is appreciated that this condition may be configurable by the queue manager, and may be limited for example by the number of connections, the number of retries, or other criteria.

Yet another technical solution comprises a secret key which may be provided to the proxy connectors during installation, with which the proxy connector can retrieve the correct parameters for accessing the message queue. The parameters may be retrieved from a computing platform external to the protected network, such as a connector manager, an installation management unit, or the like.

In some embodiments, the network may be virtually separated into two or more sub-networks, each comprising one or more servers, and one or more proxy connectors as described above. In this arrangement, each such sub-network may be associated with a separate message queue, in order to ensure that the messages are consumed by the correct proxy connector, and cause the performance of the required command by the correct server within the correct sub-network. In some embodiments, all the message queues may be aggregated into a managed cluster.

Yet another technical solution of the disclosure comprises applying the message queue and proxy connector to any type of protected network comprising any type of servers, and not necessarily PBX servers, in order to overcome network protection which does not allow incoming messages to be received.

Yet another technical solution of the disclosure comprises providing a cloud-based interface for controlling the definitions and entities of the various servers such as PBX servers, and implementing message queues. The cloud-based interface may enable execution of the stub functions for the required actions of the servers within the protected network. In this embodiment, a client device may access the interface and make the servers in the protected network execute the required functions. The interface and message queue may be executed by a cloud computing platform, which can be accessed from any client device in any location, thereby providing transparent access to the protected network from anywhere.

One technical effect of the disclosure comprises the enablement of executing RPCs in a communication network containing one or more PBXs servers, wherein the network may be protected by a security system which does not enable incoming messages. The solution enables controlled access to the internal resources of an organization, without compromising security.

Another technical effect of the disclosure comprises enhancing the solution by providing a redundancy of proxy connections, to ensure that no incoming message goes unhandled due to failure of the proxy connector.

Yet another technical effect of the disclosure comprises secure deployment and operation of the system, by installing a proxy connection and providing the proxy connection with a secret key. The secret key may then be used to retrieve configuration parameters from a system management device, for accessing the message queue and receiving messages therefrom.

Yet another technical effect of the disclosure comprises using the disclosure for enabling secure external access to any type of network protected by a protection system and any type of server within the network. Thus, the solution is not limited to PBX servers and communication networks, but may be used for any other network, such as but not limited to Enterprise Resource Planning (ERP) systems, Customer Relationship Management (CRM) platforms, healthcare information systems, financial trading networks, industrial control systems, smart city infrastructure networks, educational learning management systems, e-commerce platforms, social media networks, Content Delivery Networks (CDNs), and government or military secure communication networks.

Yet another technical effect of the disclosure comprises providing a cloud-based interface for controlling the definitions and entities of the various PBX servers and implementing the message queue. Thus, a client device may access the interface, for example through the web, and cause the servers in the protected network to execute the required functionality. Such architecture may make controlling an on-premise server as though it is cloud-based, without the extra hassle associated with migrating the server to be cloud-based.

Yet another technical effect of the disclosure may relate to the scalability of the system. The architecture utilizing message queues and connectors may allow for easy expansion of the network, accommodating additional servers, sub-networks, or even entire organizations without significant modifications to the existing infrastructure. As the system grows, new message queues and connectors can be added to handle increased load, while the core functionality remains unchanged. This scalability may enable organizations to adapt their communication systems to changing needs and growing demands without compromising security or performance.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

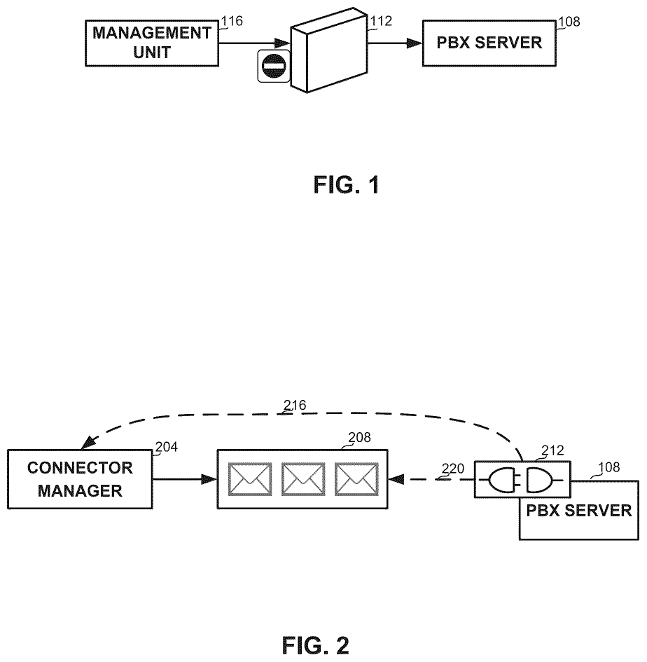

Referring now to FIG. 1, showing a schematic illustration of a network, in accordance with some exemplary embodiments of the disclosure. The network of FIG. 1 demonstrates some problems of existing technologies.

The network comprises one or more servers 108, such as but not limited to a PBX server. Thus, in the disclosure below “Server 108” and “PBX Server 108” are used interchangeably. Server 108 or information stored therein may need to be updated, for example with new users, devices, phone lines, hunt groups, or other entities relevant to the type of Server 108, may have to be configured or set up according to some parameters, or the like.

The changes or other instructions to be delivered to Server 108 may be initiated by Management Unit 116. Management Unit 116 may be a dedicated administrative console, a remote management application, or any computing device capable of initiating and managing operations on Server 108. It can be operated by system administrators, IT personnel, or automated management systems to control and configure the PBX environment. It is noted that the Management Unit 116 is an example of a “client device” that is external to the protected network and is configured to interact within components internal to the protected network.

Server 108, and optionally additional parts of the system may be protected by a Protective System 112, such as a firewall, intrusion prevention system (IPS), web application firewall (WAF), or other network security appliance. Protective System 112 may monitor and/or block communication incoming into the system. Therefore, instructions initiated by Management Unit 116 cannot be transmitted to Server 108.

Referring now to FIG. 2, showing a schematic illustration of a system architecture, in accordance with some exemplary embodiments of the disclosure.

The system may comprise one or more servers such as PBX Server 108, which may be situated within a protected section of a network, the section protected by a protection system such as a firewall. The system may comprise, optionally external to the protected section, a connection manager 204.

Additionally, or alternatively, PBX Server 108, optionally together with additional servers may be associated with a Connector 212. Connector 212 may be implemented as an application service installed on a computing device within the protected network.

Additionally, or alternatively, the system may comprise one or more Connector Managers 204 which may be used for configuring Connectors 212. Connector Managers 204 may be implemented as a service executed by a computing platform external to the protected section.

Additionally, or alternatively, the system may comprise one or more Message Queues 208, which may also be external to the protected section.

During deployment, Connector 212 may receive a secret key, which Connector 212 may provide (216) to Connector Manager 204, to obtain configuration parameters with which Connector 212 can access (220) Message Queue 208 for the purpose of dequeuing messages.

The secret key may thus be used to authenticate and securely configure the connection, thereby ensuring that only authorized instances of Connector 212 can access Message Queue 208 and interact with the network.

During operation, once deployment is completed, client devices such as Connector Manager 204 may enqueue massages to Message Queue 208. Connector 212 may then receive a message pushed into Message Queue 208, and may activate a corresponding method of PBX server 108.

The architecture of FIG. 2 thus enables the system to bypass security barriers, such as firewalls, by routing the traffic through Connector 212, thereby ensuring secure and controlled access to the internal resources of the protected section.

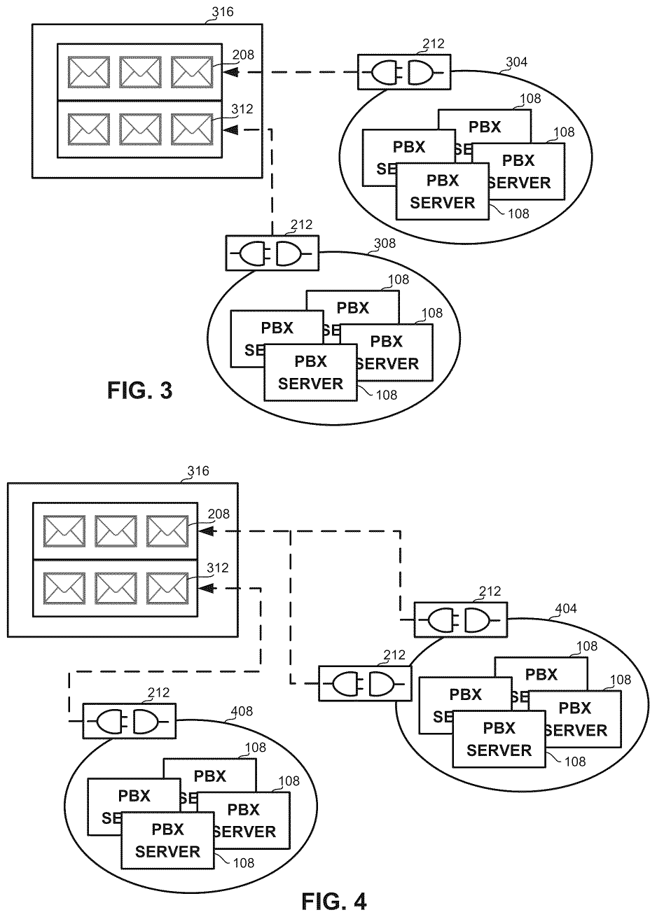

Referring now to FIG. 3, showing yet another schematic illustration of a system architecture, in accordance with some exemplary embodiments of the disclosure.

The network architecture of FIG. 3 comprises two separate protected sections, being Sections 304 and 308. Each of Section 304 and Section 308 may comprise one or more PBX servers 108, and may be protected by a protection system such as a firewall. It is understood that this embodiment is not limited to two sections and can be implemented with any number of sections, each comprising any number of servers.

Each of Section 304 and Section 308 may also comprise Connector 212 as described above, wherein Connector 212 may be implemented as an application service installed on a computing device within the respective protected network.

While Connector 212 of Section 304 may communicate with associated Message Queue 208, Connector 212 of Section 308 may communicate with associated Message Queue 312. One or more Message Queues, such as Message Queue 208 and Message queue 312 may be aggregated within a Cluster 316, such that each Message Queue 208 or Message Queue 312 serves as an access point (AP) for the associated Connector 212. Cluster 316 may be a logical grouping of one or more message queues which may share resources such as users, virtual hosts, queues, streams, exchanges, or the like. Message Queue 208 and Message Queue 312 may retain messages enqueued therein by one or more client devices, such as management unit 108, and then consumed and dequeued by the corresponding Connector 212. The client devices may retain or have access to a table or another data structure associating each section or each server with the corresponding Message Queue 208. Thus, the client device can send a message to any of the severs in any of a plurality of separate protected sections through the corresponding Message Queue 208 or Message Queue 312.

This architecture provides for activating RPC methods in a network comprising one or more separate protected sections, such that each section retains its protection and obtains messages intended exclusively for that section, without interfering with other sections.

Referring now to FIG. 4, showing yet another schematic illustration of a system architecture, in accordance with some exemplary embodiments of the disclosure.

The network architecture of FIG. 4 comprises two separate protected sections, being Sections 404 and 408. Each Section 404 and 408 may comprise one or more PBX servers 108, and may be protected by a protection system such as a firewall. It is understood that this embodiment is not limited to two sections and can be implemented with any number of sections, each comprising any number of servers.

Each protected Section 404 and 408 may also comprise one or more Connectors 212 as described above.

For example, Section 404 may comprise two or more Connectors 212, all associated with the same Message queue 208.

Connector 212 may be implemented as an application service installed on a computing device within the respective protected network. It is appreciated that Connectors 212 of Section 404 which may be implemented on one, two or more computing devices to provide redundancy, such that if one Connector 212 fails the other one(s) may still function.

Each Connector 212 of Section 404 may communicate with associated Message Queue 208, and Connector 212 of Section 408 may communicate with Message Queue 312. Message Queue 208 and Message Queue 312 may be aggregated within Cluster 316, such that each of Message Queue 208 and Message Queue 312 serves as an access point (AP) for the Connectors 212 associated therewith. Cluster 316 may be a logical grouping of one or more nodes which may share resources such as users, virtual hosts, queues, streams, exchanges, or the like. Each of Message Queue 208 and Message Queue 312 may retain messages enqueued therein by Management Unit 108 and then consumed and dequeued by the corresponding Connector 212. Management Unit 108 may retain or have access to a table or another data structure associating each section or each server with the corresponding Message Queue 208 and Message Queue 312. Thus, Management Unit 108 can send a message to any of the severs in any of a plurality of separate protected sections through the corresponding Message Queue 208 or Message Queue 312.

The plurality of Connectors 212 of Section 408 may access Message Queue 208 intermittently, switch any predetermined period of time or number of accesses, one of them may always be the first to access, or any other arrangement may be applied. If Connector 212 that consumed a message from Message Queue 208 did not report successful handling within a predetermined period of time, the other Connector 212 may access Message Queue 208, consume the message and handle it. This redundancy provides for ensuring that all messages are handled, even if one or more of Connectors 212 fail.

This architecture provides for activating RPC methods in a network comprising a plurality of separate protected sections as above but with higher certainty that all messages are indeed handled.

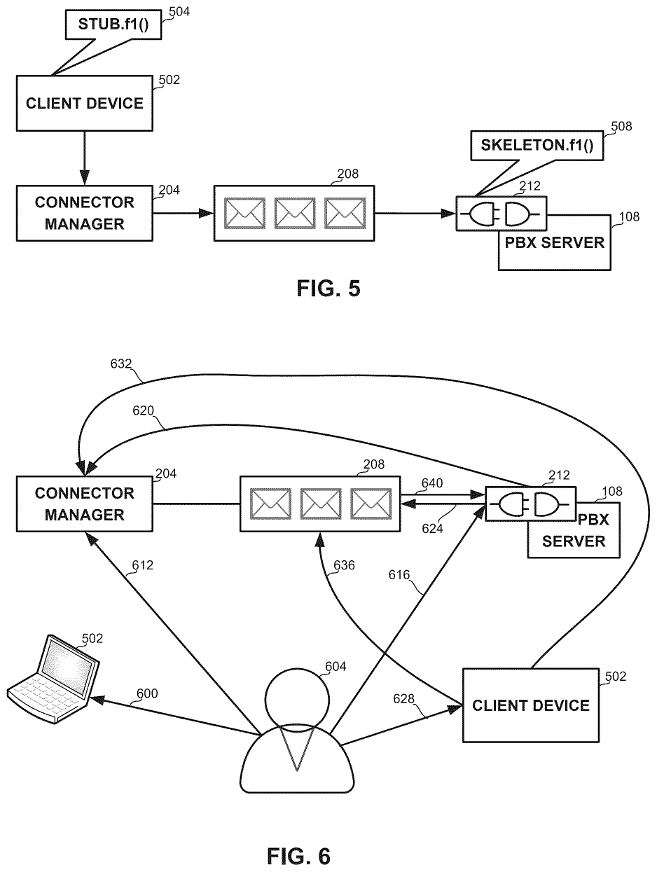

Referring now to FIG. 5, showing a schematic illustration of the architecture and functions in a system, in accordance with some exemplary embodiments of the disclosure.

The system comprises one or more Servers 108 as detailed above, and a corresponding Connector 212 installed on one of Servers 108 or on another computing platform within the protected section that PBX server 108 belongs to.

The system may further comprise Message Queue 208 associated with the protected section, which may be external to the protected section.

Client Device 502, analogous to management unit 108, may also be external to the protected section, and may be activated by a human operator, or automatically when required to send a message to one or more PBX Servers 108.

Client device 502 may comprise an implementation of one or more stub functions such as STUB.f1( ) 504, which receives an indication to an operation to be transmitted to a PBX Server 108, generates a corresponding message, and enqueues the message to Message Queue 208. In alternative embodiments, STUB.f1( ) 504 function may access Connector Manager 204 which may generate and enqueue the message.

It is appreciated that either client device 504 or Connector Manager 204 may comprise or have access to a table, database or another data structure associating the PBX Server 108 to which it is required to send a message with a message queue.

Connector 212 may then dequeue the message from Message Queue 208 and operate a skeleton function corresponding to the message, such as SKELETON.f1( ) 508. SKELETON.f1( ) 508 may activate the required function or method within one or more of the PBX servers 108 to which the message is intended, for example by operating an Application Program Interface (API) of PBX server 108.

STUB.f1( ) 504 and SKELETON.f1( ) 508 may be implemented for any function that is desired to be operated on PBX Server 108. Particularly, the functions may be enabled for a partial group of the operations enabled by PBX server 108, for which it may be beneficial to activate them from client devices external to the protected section.

Thus, a collection of methods or functions to be operated on PBX Server 108 may be created. Corresponding stub methods which create corresponding messages and enqueues them to an associated Queue Manager 208, or activate connector Manager 204 to do the same, may be automatically generated and loaded to Client Device 502.

Similarly, corresponding skeleton methods may be implemented as part of Connector 212, which may check Message Queue 208, dequeue a message, and generate a call to a corresponding function of PBX server 108.

The stub and skeleton messages may be created automatically, for example by a script that receives the headers of PBX server functions to be enabled as RPCs.

FIG. 5 may illustrate the logical flow of operations within the system. The stub function 504 in the client device 502 initiates the process by generating a message based on the desired operation. This message is then passed to the message queue 208, which acts as a buffer between the external client device and the protected network environment. Connector 212, residing within the protected network may receive a message from message queue 208, and upon receiving the message, it may invoke the corresponding skeleton function 508. This function may then interface with the PBX server 108, translating the queued message into appropriate API calls or operations on the server. This architecture ensures that no direct communication occurs between the external client device and the protected PBX server, maintaining the integrity of the network's security measures while still allowing for remote procedure calls and operations.

Referring now to FIG. 6, showing a block diagram of the entities in a system and their activities, in accordance with some exemplary embodiments of the disclosure.

At Step 600, User 604 may generate stub calls to be executed by Client Device 502. User 604 may use any automation tool, such as a plugin, for example Virtual Direct Access (VDA) plugin. User 604 may also create the corresponding skeleton functions to be executed by Connector 212. In some embodiments, the stub and skeleton functions may be generated automatically, for example by a plugin in accordance with a script.

At Step 612, a secret key may be generated for Connector 212. The secret key may be generated, for example, by User 604 or automatically, and provided to Connector Manager 204. Configuration parameters associated with the secret key may also be generated and Message Queue 208 may be set up with the parameters.

At Step 616, User 604 or another user may install Connector 212 on PBX server 108 or on another server with the protected section of PBX server 108. As part of the installation, Connector 208 may receive the secret key generated at Step 612.

At Step 620, Connector 212 may access Connector Manager 204 to obtain the configuration parameters for accessing Message Queue 208, using the secret key provided at Step 616.

At Step 624, Connector 212 may access Message Queue 208 to establish communication, using the configuration parameters obtained at Step 620.

Steps 600, 612, 616, 620 and 624 may be performed during or as part of the deployment of the system, such that the system may be ready to perform RPC commands instructed by client device 502 in spite of the protection system of the protected network.

At step 628, user 604 or another user may operate Client Device 502 or another client device, and indicate one of the Stub functions. In response, at Step 632 Client Device 502 may access Connector Manager 204 to obtain the stub function configuration, and at Step 636 Client Device 502 may invoke the stub function. Executing the stub function will cause enqueueing a message into Message Queue 208.

At step 640, Connector 212 may obtain the message and may activate a corresponding skeleton function, which may initiate the execution of a corresponding function of the indicated PBX Server 108.

Steps 628, 632, 636 and 640 may be performed repeatedly during ongoing operation of the system, where the servers may perform a collection of instructions initiated by a client device external to the protected section of the server.

It is appreciated that the scheme can be extended to multiple PBX servers 108 within a protected section, such that the multiple Servers 108 are handled by one Connector 212 communicating with Message Queue 208. The scheme may also be extended to multiple Connectors 212 serving one or more PBX Servers 108. The multiple Connectors 212 may all access the same Message Queue 208, according to any desired scheme. For example Connectors 212 may take turns in accessing Message Queue 208, or one Connector 212 may access Message Queue 208 and only if it fails another Connector 212 may access Message Queue 208 to handle the same message, or the like.

It is also appreciated that the scheme may be applicable to multiple protected sections, wherein each protected section is served by one Message Queue 208, and all Message Queues 208 may be incorporated into a cluster of message queues.

Yet another exemplary embodiment of the disclosed subject matter is a It is also appreciated that the system is not limited to a single Client Device 502, and multiple Client Devices, located on-premise, remote, as cloud computers or the like may be used.

In some exemplary embodiments, the disclosed subject matter may enable secure, asynchronous remote procedure calls from external client devices to protected PBX servers, bypassing traditional network security barriers while maintaining system integrity and control. While the system may be synchronous where the client blocks until the server responds, the solution may be made asynchronous, depending on the RPC method and on the specific implementation.

As can be appreciated, the system supports multiple client devices 502, which can be on-premises, remote, or cloud-based, providing flexibility in system access and management. Additionally, the architecture can be scaled to accommodate multiple PBX servers 108 within a single protected section, all serviced by one or more connector components 212 communicating with a single message queue 208. For enhanced reliability, multiple connector components 212 can be deployed to serve one or more PBX servers 108. These connectors can operate in various configurations, such as round-robin access to the message queue, primary-backup arrangements, or load-balancing schemes, ensuring continuous operation and fault tolerance. Furthermore, the system is designed to support multiple protected sections, each with its dedicated message queue 208. These individual queues can be aggregated into a cluster, facilitating centralized management and scalability across diverse network segments or organizational units. This comprehensive architecture provides a robust, scalable, and secure solution for executing remote procedure calls in protected network environments, particularly suited for managing and operating PBX systems across complex organizational structures.

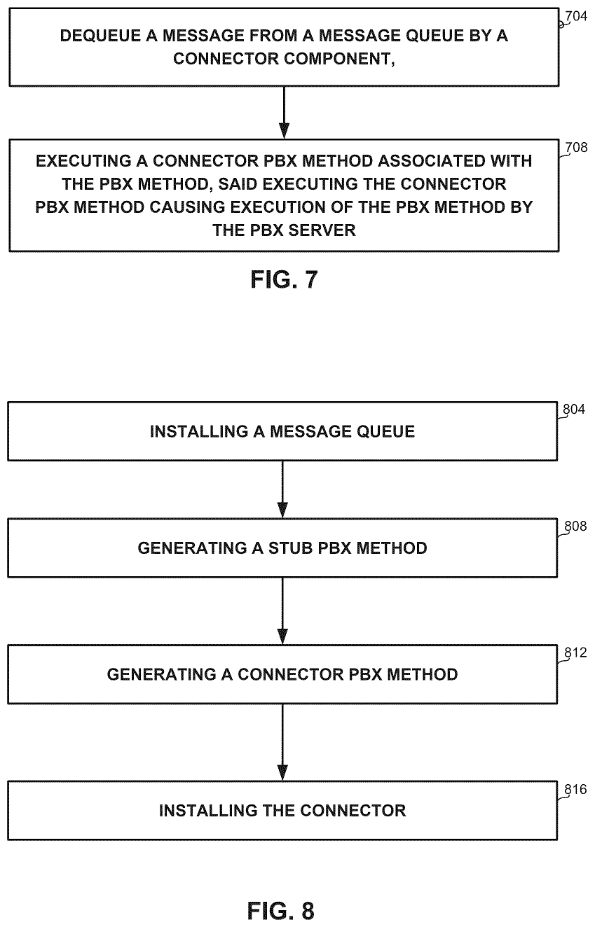

Referring now to FIG. 7, showing a flowchart of steps in a method in accordance with some exemplary embodiments of the disclosure.

The method may be performed within a computerized environment comprising a protected network, the protected network comprising a Message Queue 208, a Client Device 502, a PBX Server 108 and a device, wherein PBX server 108 and the device are within the protected network and may be the same device or different devices, Message Queue 208 and Client Device 502 are external to the protected network, and wherein direct communication from Client Device 502 to PBX Server 108 is blocked by a protection system of the network or section.

At step 704, a connector component such as Connector 212 implemented on the device, whether the device is PBX Server 108 or another computing platform. Connector 212 when executed may dequeue a message from Message Queue 208. The message may have been generated and enqueued to Message Queue 208 in response to executing a stub PBX method by Client Device 502. The message may be associated with a PBX method of PBX Server 108, and may indicate a command to execute the PBX method by a specific PBX Server 108. The message may include parameters or data required for the execution of the PBX method. Connector 212 may receive in real time or near real time messages from Message Queue 208, thus ensuring timely processing of requests. Thus, Client Device 502 may send an indirect message to PBX Server 108 without being blocked by the protection system.

At step 708, in response to dequeuing the message from Message queue 208 by Connector 212, a connector PBX method associated with the PBX method may be executed by Connector 212. Executing the connector PBX method may cause execution of the corresponding PBX method by PBX Server 108, wherein PBX Server 108 may have an API that enables invocation of a plurality of API methods. The PBX method may be comprised in a subset of the plurality of API methods, wherein the subset methods are enabled to be remotely operated via Client Device 502. The subset may comprise the PBX method and may exclude at least one other API method, such that the subset is partial to the whole set of API methods. The connector PBX method may handle any necessary data transformations or security checks before invoking the actual PBX method on the server. After execution, the connector may optionally enqueue a response message to Message Queue 208 for Client Device 502 to retrieve, providing feedback on the operation's success or failure.

The method thus enables the performance of RPCs instructed by Client Device 502 in spite of the protection system of the protected network, providing a secure and efficient mechanism for remote PBX operations ..

Referring now to FIG. 8, showing a flowchart of steps in a method in accordance with some exemplary embodiments of the disclosure.

The method may be performed during deployment of a system for enabling RPC within a computerized environment comprising a protected network. The protected network may comprise a Client Device 502, a PBX Server 108 and a device, wherein PBX server 108 and the device are within the protected network and may be the same device or different devices. Client Device 502 may be external to the network, and direct communication from Client Device 502 to PBX server 108 may be blocked by a protection system of the network or section.

At step 804, a message queue such as Message Queue 208 may be installed within the computerized network, external to the protected section. Message Queue 208 may be installed as part of a message queue cluster, comprising a plurality of message queues, each associated with one protected section of the computerized network. The message queue may be configured to receive and store messages from the client device, enabling asynchronous communication between the client device and the protected network.

At step 808, one or more stub PBX methods may be implemented. The methods may comprise a stub method for each API function of PBX Server 108 which it is required to enable remote activation for. However, stub PBX methods may not be provided for some API functions of PBX Server 108. The stub PBX methods may be configured to be executed by Client Device 502, and to enqueue, directly or through a connection manager, a corresponding message to Message Queue 208 when activated. The stub methods may act as proxies for the actual PBX server methods, allowing the client device to initiate operations on the PBX server indirectly.

At step 812, one or more connector PBX methods may be implemented, for example a connector PBX method may be implemented for each stub PBX method. The connector PBX methods may be configured to be activated in response to the connector receiving the message form Message Queue 208, and to activate a corresponding method from an API of PBX server 108. The connector methods may serve as the bridge between the message queue and the actual PBX server API, translating the queued messages into API calls.

It is appreciated that step 808 and 812 may be performed automatically, for example by a script or a plug-in receiving the list of PBX methods to be enabled for remote activation. In some exemplary embodiments, the automation ensures consistency between the stub and connector methods and facilitates easy updates when new PBX server functions need to be exposed.

At step 816, Connector 212 may be installed within the protected subnetwork. The installation may require a secret key provided to Connector 212 and sent to Connection Manager, and in response configuration parameters may be received for accessing Queue Manager 208. In some exemplary embodiments, the secure installation process may ensure that only authorized connectors can access the message queue, maintaining the integrity of the communication channel between the external client devices and the protected PBX server

It is appreciated that although the disclosure focused on PBX servers, it is in no way limited to such servers and is equally applicable to providing RPCs to any other type of servers protected by a protection system, from one or more devices external to the protected systems. For example, the disclosed method and system may be applied to database servers, application servers, file servers, web servers, or any other type of server that requires secure remote access. In alternative embodiments, the protected network may contain multiple types of servers, each with its own set of API methods that can be remotely invoked. The system could be adapted to handle different message formats and protocols depending on the server type. Additionally, the connector component could be designed to interface with various server APIs, allowing for a unified remote access solution across heterogeneous server environments. Furthermore, the system could be extended to support cloud-based servers, where the protected network spans multiple cloud platforms or hybrid cloud-on-premises configurations. In such scenarios, the message queue and connector manager could be implemented as cloud services, facilitating secure communication between on-premises and cloud-based resources.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method performed in a computerized environment, the method comprising:
dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and
in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method,
thereby performing a Remote Procedure Call (RPC) instructed by the client device in spite of the protection system of the protected network.

2. The method of claim 1, wherein the computerized environment comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components.

3. The method of claim 1, wherein the protected network comprises a plurality of sub-networks, wherein at least one sub-network from the plurality of sub-networks is associated with a separate message queue and comprising at least one PBX server.

4. The method of claim 3, wherein the at least one sub-network comprises a plurality of connectors, wherein each message enqueued to the message queue is collected by one of the plurality of connectors.

5. The method of claim 3, wherein a plurality of message queues associated with the plurality of sub-networks are managed as a queue cluster.

6. The method of claim 1, wherein the protected network is protected by a firewall.

7. The method of claim 1, wherein the message queue and an interface accessed by the client device are implemented in a cloud computer.

8. A method performed in a computerized environment, the method comprising:
installing a message queue within the computerized environment, wherein the computerized environment comprises the message queue, a client device, a PBX server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message queue is configured to receive messages from the client device;
generating a stub PBX method to be executed by the client device, the stub PBX method configured to generate a message when executed by the client device, and insert the message into the message queue, the stub PBX method is associated with a PBX method of the PBX server, the message indicating a command to execute the PBX method by the PBX server, whereby enabling the client device to send an indirect message to the PBX server without being blocked by the protection system;
generating a connector PBX method to be executed by the connector; and
installing the connector component within the protected network, the connector component configured to:
dequeuing the message from the message queue; and
in response to obtaining the message, executing a connector PBX method associated with the PBX method, said executing the connector PBX method configured to cause execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method,
thereby enabling a Remote Procedure Call (RPC) instructed by the client device in spite of the protection system of the protected network.

9. The method of claim 8, further comprising:
providing a secret key to the connector;
accessing by the connector using the secret key a source for obtaining configuration parameters; and
enabling access of the connector to the message queue using the configuration parameters.

10. The method of claim 8, wherein the protected network comprises multiple PBX servers communicating with the connector component.

11. The method of claim 8, wherein the protected network comprises a plurality of connector components accessing the message queue, thereby providing redundancy in handling the message.

12. The method of claim 8, wherein the protected network comprises a plurality of separately protected sections, each of the plurality of protected sections comprises at least one PBX server and at least one connector component, and each of the plurality of protected sections associated with a separate message queue.

13. The method of claim 12, wherein a plurality of message queues associated with the plurality of protected sections are arranged in a cluster.

14. A computerized apparatus having a processor, the processor being configured to perform:
dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and
in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method,
thereby performing a Remote Procedure Call (RPC) instructed by the client device in spite of the protection system of the protected network.

15. The computerized apparatus of claim 14, wherein the computerized environment comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components.

16. The computerized apparatus of claim 14, wherein the protected network comprises a plurality of sub-networks, wherein at least one sub-network from the plurality of sub-networks is associated with a separate message queue and comprising at least one PBX server.

17. The computerized apparatus of claim 16, wherein the at least one sub-network comprises a plurality of connectors, wherein each message enqueued to the message queue is collected by one of the plurality of connectors.

18. The computerized apparatus of claim 16, wherein a plurality of message queues associated with the plurality of sub-networks are managed as a queue cluster.

19. A computer program product comprising a non-transitory computer readable storage medium retaining program instructions, which program instructions when read by a processor, cause the processor to perform instructions comprising:
dequeuing a message from a message queue by a connector component, wherein the computerized environment comprises the message queue, a client device, a Private Branch Exchange (PBX) server, a device, and a protected network, the client device and the message queue are external to the protected network, the device and the PBX server are within the protected network, wherein direct communication from the client device to the PBX server is blocked by a protection system of the protected network, wherein the connector component is executed by the device, wherein the message is generated in response to executing a stub PBX method by the client device, the stub PBX method is associated with a PBX method of the PBX server, the message indicating a command to execute the PBX method by the PBX server, wherein the message is inserted into the message queue by the client device, whereby enabling the client device to send an indirect message to the PBX server without being blocked by the protection system; and
in response to dequeuing the message by the connector component, executing a connector PBX method associated with the PBX method, said executing the connector PBX method causing execution of the PBX method by the PBX server, wherein the PBX server has an Application Programming Interface (API) that enables invocation of a plurality of API methods, wherein the PBX method is comprised in a subset of the plurality of API methods, the subset of the plurality of API methods consists of API methods that are enabled to be remotely operated via the message queue, the subset comprises the PBX method and excludes at least one API method,
thereby performing a Remote Procedure Call (RPC) instructed by the client device in spite of the protection system of the protected network.

20. The computer program product of claim 19, wherein the computerized environment comprises a plurality of connector components, wherein each message enqueued to the message queue is collected by a first connector component of the plurality of connector components, and if handling the message is not completed by the first connector component within a predetermined period of time, the message is handled by a second connector component of the plurality of connector components.
